(19) United States
(12) Patent Application Publication
(10) Pub. No.: US 2012/0331411 A1
(43) Pub. Date: Dec. 27, 2012

(54) CROSS PROCESS ACCESSIBILITY

(75) Inventor: James W. Dempsey, San Jose, CA (US)

(73) Assignee: APPLE INC., Cupertino, CA (US)

(21) Appl. No.: 13/166,737

(22) Filed: Jun. 22, 2011

(51) Int. Cl. G06F 3/048

(52) U.S. Cl. 715/764

(57) ABSTRACT

Various representations of a graphical user interface are disclosed. In one aspect, a user interface associated with a first application can include user interface elements associated with a second application and be represented as a data structure (e.g., a tree). In another aspect, an accessibility client can traverse the data structure and interact with the user interface elements associated with the first and second applications.

### TECHNICAL FIELD

This disclosure relates generally to representations of graphical user interfaces.

### BACKGROUND

Graphical user interfaces (GUIs) provide for user-friendly interfaces for interacting with a computer and/or computer software. The GUI can include various user interface elements, such as windows, buttons, menus, menu bars, drop-down lists, scroll bars, applications (e.g., widgets), etc. Users with special needs, however, may not be able to interact with the GUI and rely on accessibility software (e.g., an accessibility client) to help them interact with the computer and/or software. For example, users with vision problems can use screen readers that audibly describe the user interface elements to the user. As another example, users with limited motor skills can use speech recognition software to enter text or interact with user interface elements.

Some accessibility clients, however, may not be able to interact with or are not compatible with applications that use or rely on a second application to generate or display user interface elements. For example, an application can be isolated and/or have limited access to system resources (e.g., a sandboxed application) and can interact with other non-sandboxed applications or operating system functions to display particular user interface elements or access particular files or directories.

### SUMMARY

Various systems and methods for representing user interface elements are disclosed. In one aspect, a user interface associated with a first application can include user interface elements associated with a second application and be represented as a data structure (e.g., a tree). In another aspect, an accessibility client can traverse the data structure and interact with the user interface elements associated with the first and second applications.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 illustrates example user interface elements.

FIG. 2 illustrates an example data structure representing the user interface elements of FIG. 1.

FIG. 3 is a flow diagram of an exemplary process for generating an example data structure to represent user interface elements.

FIG. 4 illustrates an example exchange of data between an accessibility client, a presenting application and a remote application.

FIG. 5 illustrates an example exchange of data between an accessibility client, a presenting application and a remote application.

FIG. 6 illustrates an example exchange of data between an accessibility client, a presenting application and a remote application.

FIG. 7 is a block diagram of an exemplary device architecture that implements the features and processes described with reference to FIGS. 1-6.

Like reference symbols in the various drawings indicate like elements.

### DETAILED DESCRIPTION

### Exemplary Representations of User Interface Elements

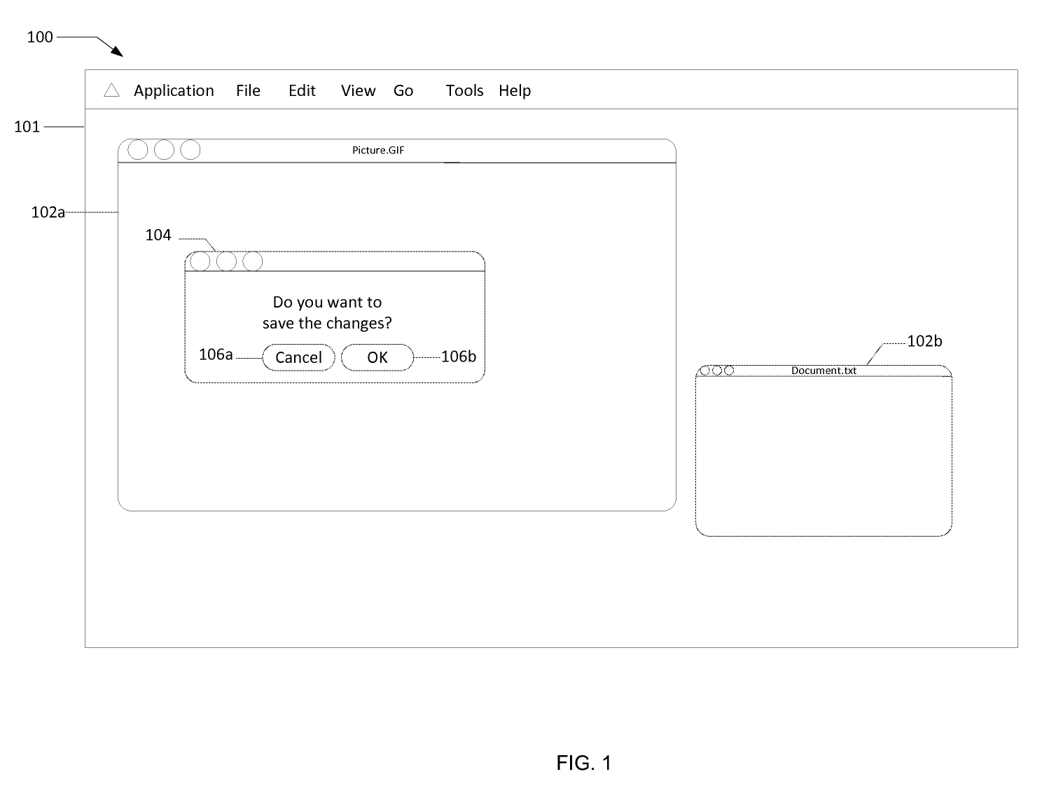

FIG. 1 illustrates example user interface elements.

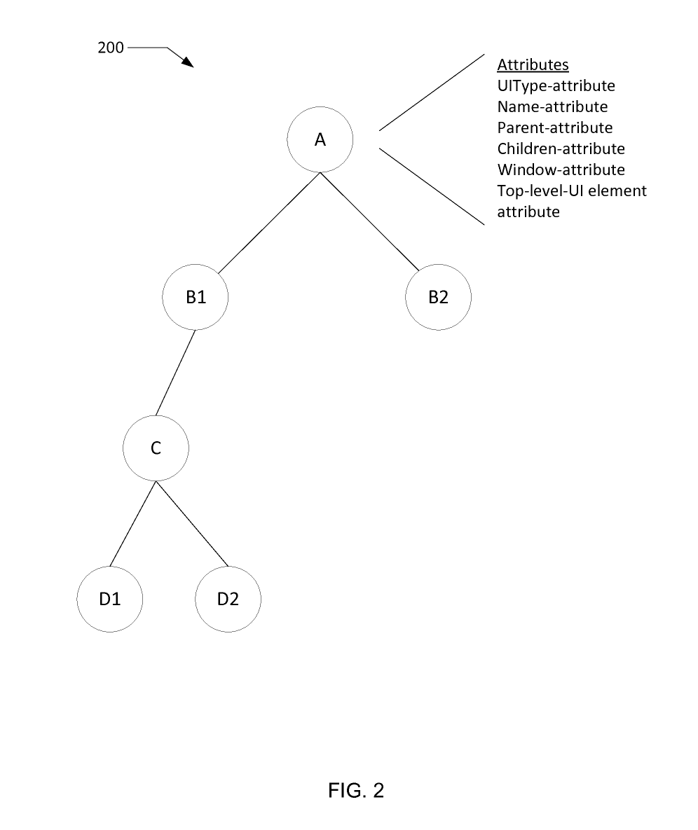

FIG. 2 illustrates an example data structure representing the user interface elements of FIG. 1.

FIG. 1 illustrates example user interface elements associated with an operating system's GUI 100. The GUI 100 can be a windows-based GUI and can include a desktop 101 and windows 102a and 102b. Although FIG. 1 only shows two windows 102a and 102b, the desktop 101 can include additional windows.

The windows 102a and 102b can be associated with various applications and operating system elements. For example windows 102a and 102b can be associated with software applications, operating system utilities/functions, directories, etc. Windows 102a and 102b can be associated with the same operating system element or can be associated with different operating system elements. For example, window 102a can be associated with an application to view digital images, such as JPEG or GIF based pictures, and window 102b can be associated with a document editor or text editor.

The windows 102a and 102b are user interface elements associated with the GUI 100 and each window 102a and 102b can include user interface elements. For example, windows 102a and 102b can include windows, menu bars, drop down menus, buttons, slide bars, etc.

In some implementations, the window 102a can be associated with a first application (e.g., a presenting application) and can include one or more user interface elements associated with a second application (e.g., a remote application). For example, the window 102a can be associated with a sandboxed image viewer (the “presenting application”) that has been isolated and has limited access to operating system resources and functions (e.g., network access) or has limited file permissions (e.g., read permission) and can call remote applications, such as non-sandboxed applications or OS functions, to display remote user interface elements or interact with particular files or directories (e.g., opening or saving a file). In some implementations, the remote application has greater access to operating system resources or functions and/or greater file permissions than the presenting application (e.g., the sandboxed application). In some implementations the remote application has greater access to operating system resources than the presenting application but does not have access to all of the operating system resources.

Remote user interface element 104 can be associated with the remote application and be displayed in the presenting application's window 102a. The remote user interface element 104 can appear as if it were generated or displayed by the presenting application leaving the user unaware that the remote user interface element 104 is generated by, displayed by or associated with the remote application. The example remote user interface element 104 is illustrated as a window that includes text and two buttons 106a and 106b. Although the remote user interface element 104 is illustrated as a window, the remote user interface element 104 can be any appropriate type of user interface element. In the example GUI 100, the remote user interface element 104 is associated with an OS function that has file write permissions.

FIG. 2 illustrates an example hierarchical data structure representation of GUI 100. The data structure 200 can be a tree-like structure that includes one or more nodes that are associated with user interface elements. For example, node A can represent the desktop 101, nodes B1 and B2 can represent the windows 102a and 102b, respectively, node C can represent the remote user interface element 104 and nodes D1 and D2 can represent buttons 106a and 106b, respectively. Each node can be generated by the operating system, the presenting application or the remote application when the user interface element associated with the node is about to be displayed.

Each node in the data structure 200 can include various attributes that describe the user interface element/node and relative position within the data structure 200. Example attributes can include a UIType-attribute, a ID-attribute, a parent-attribute, a children-attribute, a window-attribute and a top-level-UI element attribute. The UIType-attribute can describe what type of user-interface element is represented by the node. For example, the UIType-attribute can have values such as window, menu bar, menu, menu item, button, button control, slider, etc. The ID-attribute can be a token or descriptor associated with the node that can be used as a reference to the node (e.g., an alpha-numeric identifier or name). For example, node B1 can have an ID-attribute equal to “UIRef B1.” The parent-attribute can include a reference or token associated with the node's parent. For example, node B1 can have a parent-attribute equal to desktop 101/node A's ID-attribute (e.g., “UIRef A”). The children-attribute can include references or tokens associated with the user interface/node's children. For example, node B1 can have a children-attribute equal to a reference to remote user interface element 104/node C (e.g., “UIRef C”), and node A can have a children attribute equal to a reference to window 102a and 102b (e.g., “UIRef B1” and “UIRef B2”). The window-attribute can include a reference or token associated with the window (if any) containing the user-interface element represented by the node. For example, node B can have a window-attribute equal to NULL because window 102a is not included in another window and node D1 can have a window attribute equal to a reference associated with remote user interface element 104/node C (e.g., “UIRef C”). The top-level-UI element attribute can include a reference or token associated with the user interface element that contains the user interface element represented by the node (e.g., a container element such as a window, sheet or drawer). For example, the button 106a/node D1 can have a top-level-UI element attribute equal to a reference to window 102a/node B1 (e.g., “UIRef B1”). In some implementations, the top-level-UI element attribute can be the same as the window-attribute. In some implementations, each node includes a focus-attribute that can indicate whether the user interface element associated with the node is active and can receive keyboard input. For example, if a user is entering text into a text-field the focus-attribute associated with the text-field can have a value of “active” or “1.” The operating system, the presenting application or the remote application can update the value of the focus-attribute based on the user's interaction with the user interface elements.

A node can be queried and, in response, can return its attribute values. For example, an application can query node B1, and in response, node B1 can return its attribute values. In some implementations, the node can be queried for a particular attribute. For example, a node can be queried to return its parent-attribute. In addition, a node's attribute values can be updated by an application or by another node. For example, when a user interface element, such as a button, is generated, a new node is generated and its attribute values are updated by the application displaying the user interface element. The attributes of the new node's parent are also updated to reflect new child node.

The data structure 200 can be traversed. For example, a software application, such as an accessibility client, can traverse the data structure 200 to collect information describing the GUI. The accessibility client can provide the information to a special-needs user so the special-needs user can interact with the GUI. In some implementations, the accessibility client starts at the root node of the data structure 200 (e.g., node A) and uses the children-attribute and the parent-attribute of each node to traverse the data structure 200. As the accessibility client traverses the data structure 200, the accessibility client can store attribute values associated with each node, such as the UIType-attribute, the parent-attribute and the children-attribute. The data structure 200 can be traversed starting at any node within the data structure 200. For example, an accessibility client can start a traversal of the data structure 200 at node C, which represents the remote user interface element 104.

### Exemplary Process

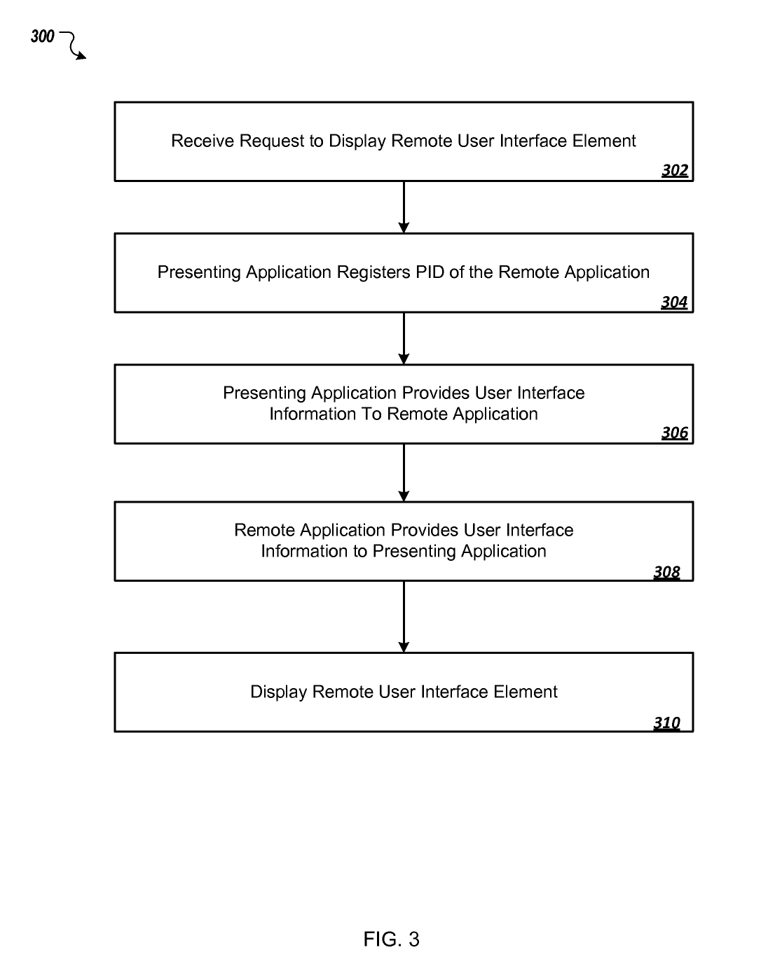

FIG. 3 is a flow diagram of an exemplary process for generating an example data structure to represent user interface elements.

Exemplary process 300 can begin by receiving a request to display a remote user interface element (at 302). For example, a sandboxed application, such as a presenting application associated with window 102a, can receive an instruction to display a remote user interface element 104 (e.g., a window to open or save a file). In some implementations, the sandboxed presenting application receives the instruction as a result of a user input, such as the user clicking on an user interface element (e.g., a menu or button) or entering a keyboard command (e.g., “cmd-s” or “cmd-o”).

Process 300 can continue by registering the process identification (“PID”) of the remote application (at 304). For example, the presenting application can request that the remote application provide it with the remote application's PID and store/register the PID. In some implementations, the PID can be a token or a descriptor associated with an application that uniquely identifies the application. The presenting application can store the PID in a memory location such that the presenting application can provide the PID to other applications, such as an accessibility client.

Process 300 can continue by providing user interface information to the remote application (at 306). For example, the presenting application can provide user interface information associated with window 102a to the remote application. The presenting application can access window 102a's attributes and provide at least a subset of the attribute values, such as a set of required attributes (e.g., the window 102a's ID-attribute value), to the remote application. In some implementations, the presenting application can also provide the remote application with its window-attribute value and top-level-UI element attribute value. In addition, the presenting application can provide the remote application with the presenting application's PID.

In response to receiving the presenting application's user interface information, the remote application can create a node to represent the remote user interface element 104. For example, the remote application can generate a node (e.g., node C) to represent the remote user interface element 104. The remote application can update the node's attributes based on the values received from the presenting application. For example, the node C's parent-attribute can be equal to window 102a/node B1's ID-attribute value. This can allow the remote user interface element to return window 102a's ID-attribute value when it is queried for its parent-attribute. In addition, the remote application can set node C's top-level-UI element attribute and node C's window attribute to be equal to the corresponding attribute values associated with the window 102a/node B1. In some implementations, the remote application can associate the presenting application's PID with the remote user interface element 104.

Process 300 can continue by receiving user interface information from the remote application (at 308). For example, the remote application can provide the ID-attribute value associated with remote user interface element 104/node C to the presenting application. In response, the presenting application can set window 102a's children-attribute to be equal to the remote user interface element's ID-attribute. Process 300 can continue by displaying the remote user interface element (at 310).

### Exemplary Data Exchanges

The following illustrative examples of data exchanges are described in connection with FIG. 1 and FIG. 2.

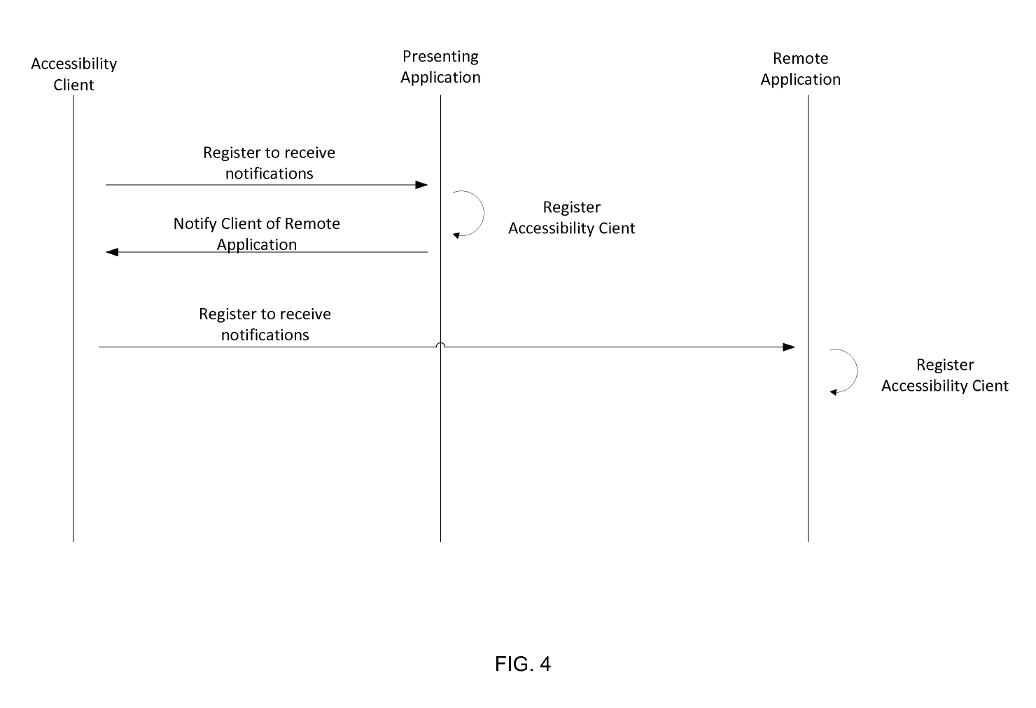

FIG. 4 illustrates example data exchanges associated with registering an accessibility client such that the accessibility client receives notifications from the presenting application. For example, an accessibility client can receive a notification or alert from the presenting application each time a user interface element associated with the presenting application (e.g., window 102a) is updated or changed (e.g., a new window 104 is displayed or a pull down menu is activated).

The accessibility client sends an instruction to the presenting application that it should receive notifications or messages each time the user interface elements associated with window 102a are updated or changed. The accessibility client can provide the presenting application with its PID, which the presenting application can store and use to provide notifications to the accessibility client.

After the presenting application registers the accessibility client, it can notify the accessibility client that at least one of its user interface elements are associated with a remote application. For example, window 102a can transmit a message to the accessibility client that includes the remote application's PID.

The accessibility client can send an instruction to the remote application that it should receive notifications or messages each time the user interface elements included in window 102a and associated with the remote application are updated or changed. The accessibility client can provide the presenting application with its PID, which the remote application can store and use to provide notifications to the accessibility client.

After the accessibility client has registered to receive notifications, each time a user interface element associated with the presenting application or the remote application is updated or created, the accessibility client can receive a notification or message.

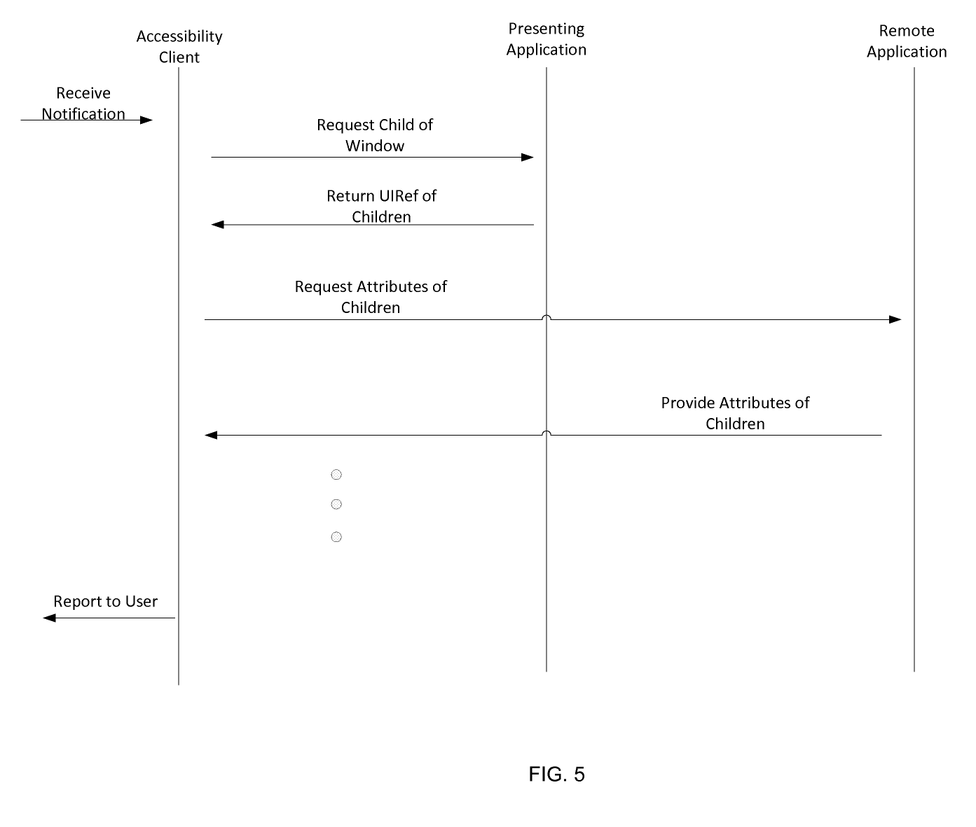

FIG. 5 illustrates an example exchange of data associated with an accessibility client's downward traversal of a presenting application's user interface elements (e.g., window 102a/node B1).

An accessibility client can receive a notification that a user interface element associated with window 102a has changed. In response, the accessibility client can then query window 102a to receive the user interface elements associated with the window 102a. For example, the accessibility client can request that window 102a provide the accessibility client with its children-attribute. The application associated with window 102a can provide the accessibility client with its children-attribute values. For example, window 102a can provide the tokens or references associated with window 104/node C (e.g., “UIRef C”).

The accessibility client can then request the attributes associated with window 104 to determine if window 104 is a leaf of the data structure 200 (e.g., a node with no children) or if window 104 is associated with its own children user interface elements. In response, the remote application associated with window 104 provides the accessibility client with window 104's children-attribute values. For example, the remote application can provide the accessibility client with the tokens or references associated with the buttons 106a and 106b (e.g., “UIRef D1” and “UIRef D2”).

Although not shown in FIG. 4, the accessibility client can continue traversing window 104's user interface structure by requesting that the remote application report the children-attribute values associated with buttons 106a and 106b. In this way, the accessibility client can traverse window 102a's user interface structure and generate a description of all of window 102a's user interface elements.

After the accessibility client has traversed the user interface elements associated with window 102a, the accessibility client can report window 102a's user interface structure to a requesting application through an Application Programming Interface (API). For example, the accessibility client can provide an audio description of window 102a and the user interface elements associated with window 102a (e.g., user interface elements represented by node B1, node C, node D1 and node D2).

An analogous exchange of data can occur during an upward traversal of window 102's user interface structure. For example, an analogous exchange of data can occur if the accessibility client were to traverse the data structure 200 starting from window 104a.

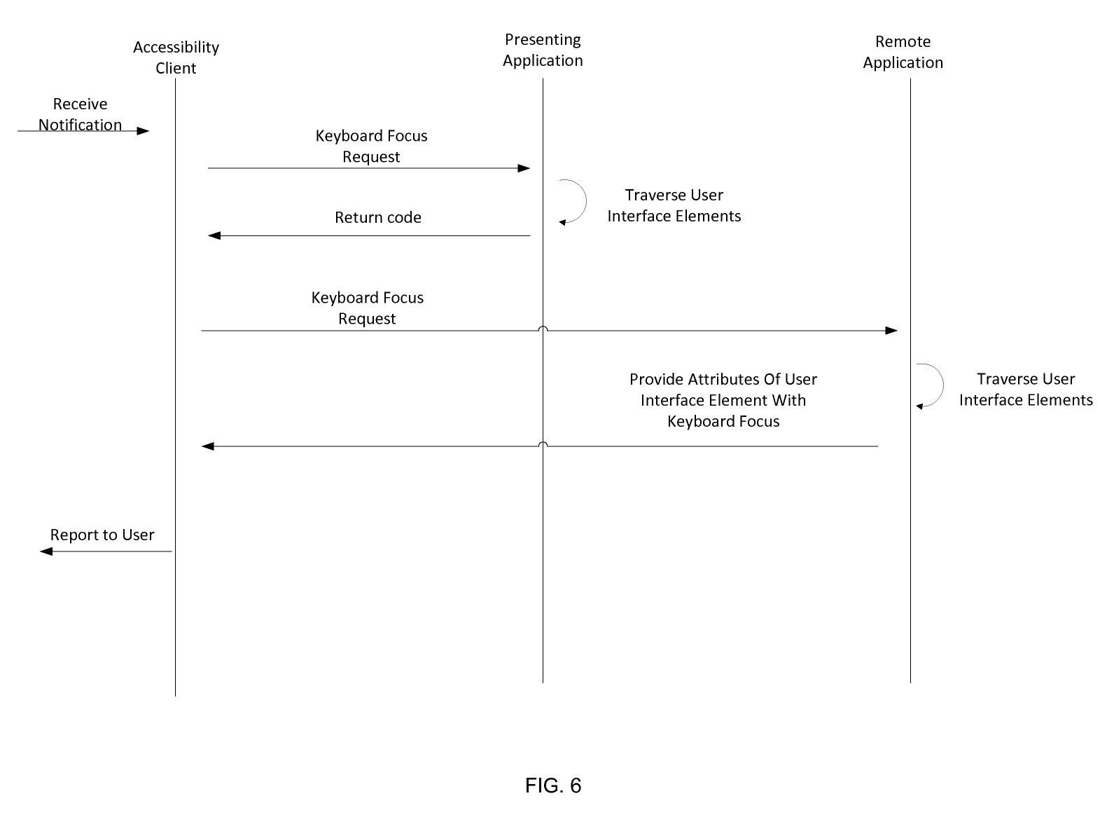

FIG. 6 illustrates an example exchange of data associated with an accessibility client's keyboard focus testing of a presenting application's user interface elements (e.g., window 102a/node B1).

An accessibility client can request that an application, e.g., the presenting application, identify the user interface element that is active and can receive keyboard input (e.g, a keyboard focus request). For example, the accessibility client can query window 102a to determine which of its user interface elements, if any, has the keyboard focus. The application associated with the window 102a can traverse its user interface hierarchy and analyze each node's focus-attribute until it reaches a user interface element that is associated with a remote application (e.g., window 104).

After the remote user interface element is reached, the application associated with window 102a can return a code to the accessibility client. For example, the application associated with window 102a can return an error code that includes the remote application's PID. In some implementations, the code is a redirection code that indicates that the accessibility client should query the remote application for the user interface element with the keyboard focus.

After receiving the code, the accessibility client can query the remote application to provide information associated with the user interface element that has the keyboard focus. For example, the accessibility client can use the remote application's PID to direct the query to the remote application. The remote application can traverse its user interface elements and analyze each node's focus-attribute to determine which of its user interface elements have the keyboard focus.

After identifying the user interface element that has the keyboard focus, the remote application can provide at least some of the attributes associated with the user interface element to the accessibility client. For example, the remote application can provide the accessibility client the ID-attribute and the UIType-attribute. The accessibility client can provide this information to a user. For example, the accessibility client can provide an audio description of the user interface element that has the keyboard focus.

### Exemplary Device Architecture

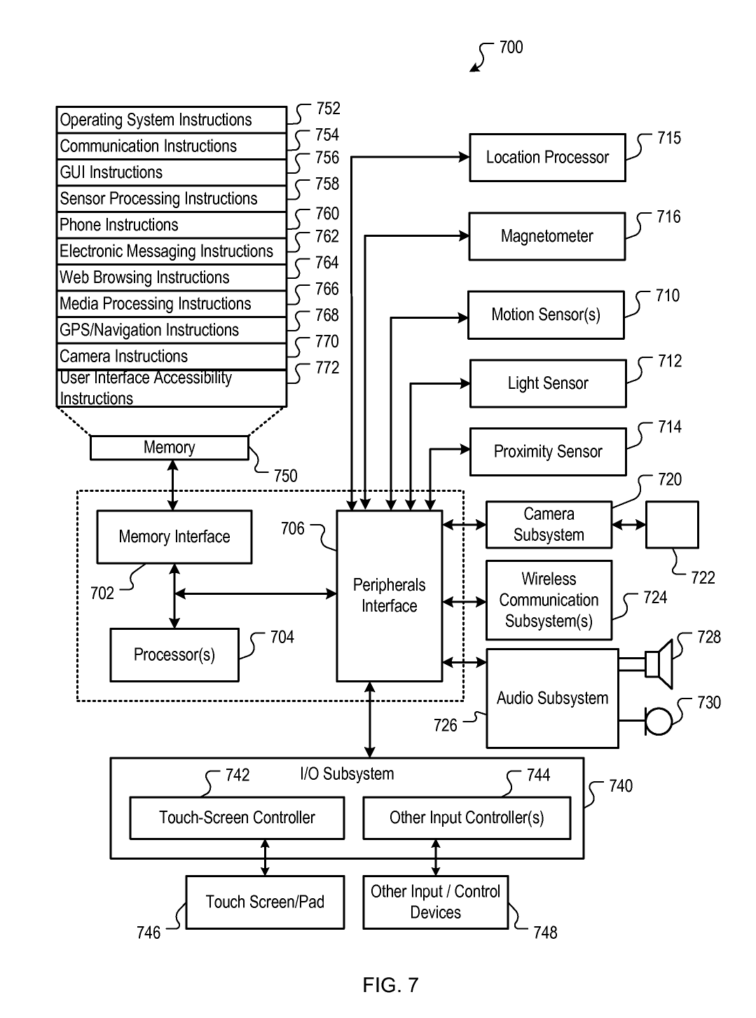

FIG. 7 is a block diagram illustrating exemplary device architecture implementing features and operations described in reference to FIGS. 1-5. Device 700 can be any device capable of displaying a GUI and user interface elements. Device 700 can include memory interface 702, one or more data processors, image processors or central processing units 704, and peripherals interface 706. Memory interface 702, processor(s) 704 or peripherals interface 706 can be separate components or can be integrated in one or more integrated circuits. The various components can be coupled by one or more communication buses or signal lines.

Sensors, devices, and subsystems can be coupled to peripherals interface 706 to facilitate multiple functionalities. For example, motion sensor 710, light sensor 712, and proximity sensor 714 can be coupled to peripherals interface 706 to facilitate orientation, lighting, and proximity functions of the mobile device. For example, in some implementations, light sensor 712 can be utilized to facilitate adjusting the brightness of touch screen 746. In some implementations, motion sensor 710 (e.g., an accelerometer, gyros) can be utilized to detect movement and orientation of the device 700. Accordingly, display objects or media can be presented according to a detected orientation, e.g., portrait or landscape.

Other sensors can also be connected to peripherals interface 706, such as a temperature sensor, a biometric sensor, or other sensing device, to facilitate related functionalities.

Location processor 715 (e.g., GPS receiver) can be connected to peripherals interface 706 to provide geo-positioning. Electronic magnetometer 716 (e.g., an integrated circuit chip) can also be connected to peripherals interface 706 to provide data that can be used to determine the direction of magnetic North. Thus, electronic magnetometer 716 can be used as an electronic compass.

Camera subsystem 720 and an optical sensor 722, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 724. Communication subsystem(s) 724 can include one or more wireless communication subsystems. Wireless communication subsystems 724 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 724 can depend on the communication network(s) or medium(s) over which device 700 is intended to operate. For example, a mobile device can include communication subsystems 724 designed to operate over a GSM network, a GPRS network, an EDGE network, a WiFi or WiMax network, and a Bluetooth network. In particular, the wireless communication subsystems 724 can include For example, device 700 may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 724 may include hosting protocols such that the mobile device 700 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 726 can be coupled to a speaker 728 and one or more microphones 730 to facilitate voice-enabled functions, such as voice recognition, voice replication, digital recording, and telephony functions.

I/O subsystem 740 can include touch screen controller 742 and/or other input controller(s) 744. Touch-screen controller 742 can be coupled to a touch screen 746 or pad. Touch screen 746 and touch screen controller 742 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 746.

Other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of speaker 728 and/or microphone 730.

In one implementation, a pressing of the button for a first duration may disengage a lock of the touch screen 746; and a pressing of the button for a second duration that is longer than the first duration may turn power to mobile device 700 on or off. The user may be able to customize a functionality of one or more of the buttons. The touch screen 746 can also be used to implement virtual or soft buttons and/or a keyboard.

In some implementations, device 700 can present recorded audio and/or video files, such as MP3, AAC, and MPEG files. In some implementations, device 700 can include the functionality of an MP3 player and may include a pin connector for tethering to other devices. Other input/output and control devices can be used.

Memory interface 702 can be coupled to memory 750. Memory 750 can include high-speed random access memory or non-volatile memory, such as one or more magnetic disk storage devices, one or more optical storage devices, or flash memory (e.g., NAND, NOR). Memory 750 can store operating system 752, such as Darwin, RTXC, LINUX, UNIX, OS X, WINDOWS, or an embedded operating system such as VxWorks. Operating system 752 may include instructions for handling basic system services and for performing hardware dependent tasks. In some implementations, operating system 752 can include a kernel (e.g., UNIX kernel).

Memory 750 may also store communication instructions 754 to facilitate communicating with one or more additional devices, one or more computers or one or more servers. Communication instructions 754 can also be used to select an operational mode or communication medium for use by the device, based on a geographic location (obtained by the GPS/Navigation instructions 768) of the device. Memory 750 may include graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes and instructions; camera instructions 770 to facilitate camera-related processes and functions; user interface accessibility instructions 772 for the processes and features described with reference to FIGS. 1-5; text-to-speech instructions 774 for implementing the TTS engine 210 and voice database 776. The memory 750 may also store other software instructions for facilitating other processes, features and applications.

Each of the above identified instructions and applications can correspond to a set of instructions for performing one or more functions described above. These instructions need not be implemented as separate software programs, procedures, or modules. Memory 750 can include additional instructions or fewer instructions. Furthermore, various functions of the mobile device may be implemented in hardware and/or in software, including in one or more signal processing and/or application specific integrated circuits.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to, communicate with, one or more mass storage devices for storing data files; such devices include magnetic disks, such as internal hard disks and removable disks; magneto-optical disks; and optical disks.

Storage devices suitable for tangibly embodying computer program instructions and data include all forms of non-volatile memory, including by way of semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a player, the features can be implemented on a computer having a display device, such as a CRT (cathode ray tube) or LCD (liquid crystal display) monitor for displaying information to the player. The computer can also have a keyboard and a pointing device such as a game controller, mouse or a trackball by which the player can provide input to the computer.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A computer-implemented method comprising:
displaying a first user interface element, wherein the first user interface element is associated with a first application;
receiving a request to display a second user interface element, wherein the second user interface element is associated with a second application and is associated with the first user interface element;
providing, from the first application, user interface information associated with the first user interface element to the second application;
receiving, at the first application, user interface information associated with the second user interface element from the second application; and
displaying the second user interface element.

2. The computer-implemented method associated with claim 1, wherein the first application is at least partially isolated from operating system resources and is associated with a limited set of permissions.

3. The computer-implemented method associated with claim 2, wherein the limited set of permissions is less than the permissions associated with the second application.

4. The computer-implemented method associated with claim 1, wherein the user interface information associated with the first user interface element includes a first ID-attribute and wherein the user interface information associated with the second user interface element includes a second ID-attribute.

5. The computer-implemented method associated with claim 4, further comprising:
storing the first ID-attribute as a parent-attribute associated with the second user interface element; and
storing the second ID-attribute as a child-attribute associated with the first user interface element.

6. The computer-implemented method of claim 1 wherein the first application comprises a presenting application.

7. The computer-implemented method of claim 1, wherein the second application comprises a remote application.

8. The computer-implemented method of claim 1, wherein the first user interface element includes the second user interface element.

9. A computer-implemented method comprising:
providing an indication to a client that a first user interface element changed, wherein the first user interface element is associated with a first application and comprises a second user interface element associated with a second application;
providing user interface information associated with the first user interface element to the client; and
providing user interface information associated with the second user interface element to the client in response to a request from the client, wherein the request is based on the user interface information associated with the first user interface element, wherein the client is configured to report at least a portion of the user interface information associated with the first user interface element and at least a portion of the user interface information associated with the second user interface element to a user.

10. The computer-implemented method of claim 9 further comprising:
registering the client to receive the indication prior to providing the indication.

11. The computer-implemented method of claim 9 wherein the indication comprises a notification that a first user interface element changed.

12. The computer-implemented method of claim 9 wherein the first user interface element includes the second user interface element.

13. The computer-implemented method associated with claim 9, wherein the first application is at least partially isolated from operating system resources and is associated with a limited set of permissions.

14. The computer-implemented method associated with claim 13, wherein the limited set of file permissions is less than the permissions associated with the second application.

15. The computer-implemented method associated with claim 9 wherein the client comprises an accessibility client.

16. The computer-implemented method associated with claim 9 wherein the user interface information associated with the first application comprises child-attribute data associated with the first user interface element.

17. A system comprising:
one or more processors;
memory storing instructions, which, when executed by the one or more processors, causes the one or more processors to perform operations comprising:
displaying a first user interface element, wherein the first user interface element is associated with a first application;
receiving a request to display a second user interface element, wherein the second user interface element is associated with a second application and is associated with the first user interface element;
providing, from the first application, user interface information associated with the first user interface element to the second application;
receiving, at the first application, user interface information associated with the second user interface element from the second application; and
displaying the second user interface element.

18. The system of claim 17, wherein the first application is at least partially isolated from operating system resources and is associated with a limited set of permissions.

19. The system of claim 18, wherein the limited set of permissions is less than the permissions associated with the second application.

20. The system of claim 17, wherein the user interface information associated with the first user interface element includes a first ID-attribute and wherein the user interface information associated with the second user interface element includes a second ID-attribute.

21. The system of claim 20, wherein the memory storing instructions, which, when executed by the one or more processors, causes the one or more processors to perform operations further comprising:
storing the first ID-attribute as a parent-attribute associated with the second user interface element; and
storing the second ID-attribute as a child-attribute associated with the first user interface element.

22. The system of claim 17, wherein the first application comprises a presenting application.

23. The system of claim 17, wherein the second application comprises a remote application.

24. The system of claim 17, wherein the first user interface element includes the second user interface element.
